(19) United States
(12) Patent Application Publication
(10) Pub. No.: US 2011/0029735 A1
(43) Pub. Date: Feb. 3, 2011

(54) METHOD FOR MANAGING AN EMBEDDED SYSTEM TO ENHANCE PERFORMANCE THEREOF, AND ASSOCIATED EMBEDDED SYSTEM

(76) Inventors: Ying-Chieh Chiang, Taipei City (TW); Wei-Hsien Lin, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/511,040

(22) Filed: Jul. 28, 2009

(51) Int. Cl. G06F 12/08; G06F 12/00

(52) U.S. Cl. 711/125; 711/154; 711/E12.001; 711/E12.017

(57) ABSTRACT

A method for managing an embedded system is provided. The method includes selecting one of a first memory and a second memory according to at least one criterion, where the selected memory is a source from which the embedded system reads commands of a program, and an access speed of the first memory is different from that of the second memory; and controlling the embedded system to execute the program by utilizing the selected memory as the source.

### BACKGROUND

The disclosed embodiments relate to embedded systems, and more particularly, to a method for managing an embedded system to enhance performance thereof, and to an associated embedded system.

Embedded systems have been utilized in many electronic devices such as cellular phones and personal digital assistants (PDAs). Typically, the hardware resources of the embedded systems are limited due to compact design. For those who are eager to achieve a goal of reducing cost, the situation will become worse since the hardware resources of the embedded systems will become strictly limited. As a result, almost all low cost embedded systems suffer from some performance degradation. For example, the operation speed is slow, and the memory bandwidth is sometimes insufficient. Therefore, a method is required for enhancing the performance of the embedded systems.

### SUMMARY

An exemplary embodiment of a method for managing an embedded system comprises: selecting one of a first memory and a second memory according to at least one criterion, wherein the selected memory is a source from which the embedded system reads commands of a program, and an access speed of the first memory is different from that of the second memory; and controlling the embedded system to execute the program by utilizing the selected memory as the source.

An exemplary embodiment of an embedded system comprises a cache and a processor. The cache is arranged to cache information for the embedded system. In addition, the processor is arranged to control operations of the embedded system, where the processor selects one of a first memory and a second memory according to at least one criterion, and the selected memory is a source from which the embedded system reads commands of a program. In particular, an access speed of the first memory is different from that of the second memory. Additionally, the processor controls the embedded system to execute the program by utilizing the selected memory as the source.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an embedded system according to a first embodiment of the present invention.

FIG. 2 is a flowchart of a method for managing an embedded system according to one embodiment of the present invention.

FIG. 3 illustrates a control procedure according to an embodiment of the present invention.

FIG. 4 illustrates a control procedure according to another embodiment of the present invention.

FIG. 5 is a diagram of an embedded system according to a second embodiment of the present invention.

FIG. 6 illustrates an exemplary plurality of programs according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

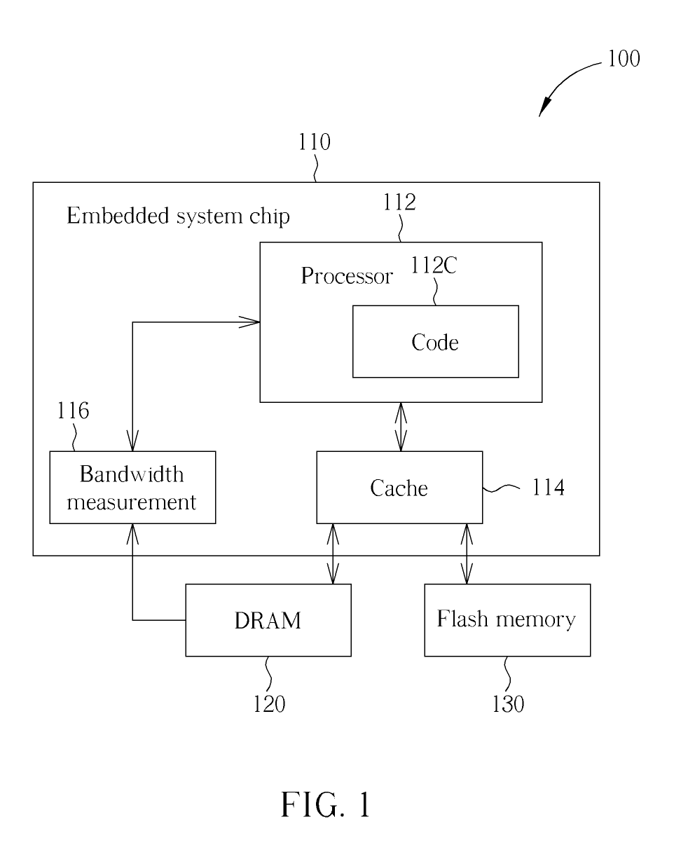

FIG. 1 shows an embedded system 100 according to a first embodiment of the present invention. The embedded system 100 comprises a processor 112, a cache 114, and a bandwidth measurement unit 116 (labeled “Bandwidth measurement” in FIG. 1), and further comprises a first memory and a second memory, where the second memory is a volatile memory such as a dynamic random access memory (DRAM) 120, and the first memory is a non-volatile memory such as a Flash memory 130. According to this embodiment, the processor 112, the cache 114, and the bandwidth measurement unit 116 are integrated into an integrated circuit (IC) of the embedded system 100, such as an embedded system chip 110, while the DRAM 120 and the Flash memory 130 are considered as a portion of the embedded system 100. It should be noted that this is for illustrative purposes only, and is not meant to be a limitation of the present invention. According to another embodiment, the DRAM 120 or the Flash memory 130 can be considered as a component positioned outside the embedded system 100.

According to this embodiment, under control of a program code, such as the code 112C in FIG. 1, the processor 112 is arranged to control operations of the embedded system 100, and the cache 114 is arranged to cache information for the embedded system 100 either from the first or second memories, where the first memory such as the Flash memory 130 stores a plurality of programs to be executed by the embedded system 100, and more particularly, by the processor 112. Further, under the control of the code 112C, the processor 112 is capable of selecting a memory from the first memory or the second memory (e.g. the Flash memory 130 or the DRAM 120) according to at least one criterion, where the selected memory is a source from which the embedded system 100 can read commands of at least one program. As a result, the processor 112 controls the embedded system 100 to execute the program by utilizing the selected memory as the source.

Typically, the access speed of the first memory is different from that of the second memory. In particular, the access speed of the second memory is higher than that of the first memory. The processor 112 copies the commands of the program from the first memory to the second memory in advance in order to control the embedded system 100 to execute the program by utilizing the second memory as the source, when the selected memory is the second memory. For example, in a situation where the access speed of the DRAM 120 is faster than the access speed of the Flash memory 130, the processor 112 copies the commands of the program from the Flash memory 130 to the DRAM 120 in advance in order to control the embedded system 100 to execute the program by utilizing the DRAM 120 as the source, when the selected memory is the DRAM 120.

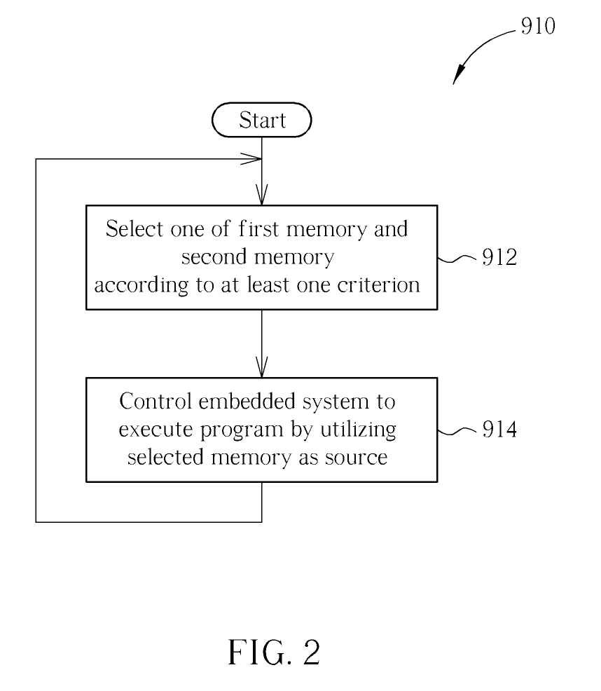

According to this embodiment, the bandwidth measurement unit 116 (labeled “Bandwidth measurement” in FIG. 1) can generate at least one memory bandwidth measurement result by detecting some characteristics of the DRAM 120, and the processor 112 can obtain the memory bandwidth measurement result generated by the bandwidth measurement unit 116 when needed. Alternatively, the DRAM 120 can send an interrupt to the processor 112 via the bandwidth measurement unit 116. In addition, the processor 112 can enable or disable operations of the bandwidth measurement unit 116. The processor 112 can also configure the bandwidth measurement unit 116 as required. Further details are explained in the following by referring to FIG. 2.

FIG. 2 is a flowchart of a method 910 for managing an embedded system to enhance performance thereof according to one embodiment of the present invention. The method 910 can be applied to the embedded system 100 and is described as follows.

In Step 912, under the control of the code 112C, the processor 112 selects one of the first memory (e.g. the Flash memory 130) and the second memory (e.g. the DRAM 120) according to at least one criterion, where the selected memory is the source from which the embedded system 100 reads commands of at least one program. In an embodiment, the criterion corresponds to a program type of the program. In another embodiment, the criterion corresponds to at least one memory bandwidth measurement result of one of the first memory and the second memory, where the bandwidth measurement unit 116 is arranged to generate the memory bandwidth measurement result. Thus, from the bandwidth measurement unit 116, the processor 112 obtains the at least one memory bandwidth measurement result of one of the first memory and the second memory. Subsequently, the processor 112 determines whether the memory bandwidth measurement result is greater than a memory bandwidth measurement threshold, and selects one of the first memory and the second memory according to a determined result thereof. Still in another embodiment, the at least one criterion comprises a plurality of criteria comprising a first criterion and a second criterion, where the first criterion corresponds to at least one memory bandwidth measurement result of one of the first memory and the second memory, and the second criterion corresponds to a program type of the program.

In Step 914, under the control of the code 112C, the processor 112 controls the embedded system 100 to execute the program by utilizing the selected memory as the source. For example, when the first memory is selected, the processor 112 caches commands of a first program from the first memory such as the Flash memory 130 for the embedded system 100 with the cache 114, and controls the embedded system 100 to execute the first program by utilizing the Flash memory 130 as the source. In addition, in a situation where the processor 112 copies commands of a second program from the first memory to the second memory in advance, the processor 112 caches the commands of the second program from the second memory such as the DRAM 120 for the embedded system 100 with the cache 114, and controls the embedded system 100 to execute the second program by utilizing the DRAM 120 as the source.

Please note that, as both the processor 112 for executing the first and the second programs and the cache 114 for caching the commands of the first and the second programs are integrated into the embedded system chip 110, and as the first memory and the second memory are not integrated into the embedded system chip 110, the cache 114 is the only cache of the embedded system 100 during execution of the first program and the second program. According to this embodiment, by properly selecting one of the first and second memories as the source, the processor 112 can manage the memory bandwidth between the embedded system 100 and the DRAM 120 in an optimal manner, in order to enhance the performance of the embedded system 100.

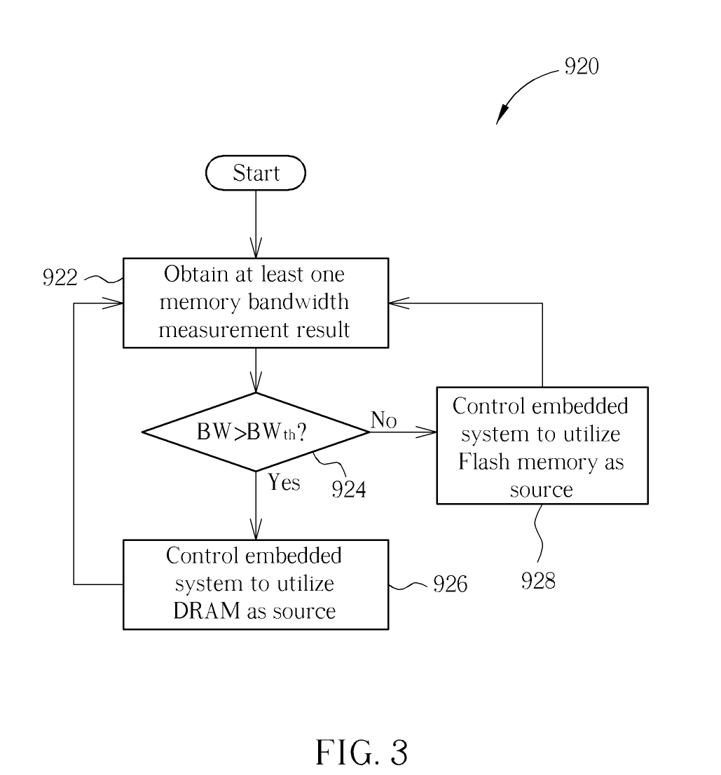

FIG. 3 illustrates a control procedure 920 comprising implementation details of the method 910 shown in FIG. 2 according to an embodiment of the present invention, where this embodiment is an operational scenario of the embodiment shown in FIG. 2. The control procedure 920 is described as follows.

In Step 922, under the control of the program code such as a code 112C′, which is a varied version of the code 112C, the processor 112 obtains at least one memory bandwidth measurement result BW. In this embodiment, the memory bandwidth measurement result BW indicates the DRAM transmission capability available for the embedded system 100.

In Step 924, under the control of the code 112C′, the processor 112 determines whether the memory bandwidth measurement result BW is greater than a memory bandwidth measurement threshold BWₜₕ. If the processor 112 determines that the memory bandwidth measurement result BW is greater than the memory bandwidth measurement threshold BWₜₕ, the control procedure 920 goes to Step 926; otherwise, the control procedure 920 goes to Step 928.

In Step 926, under the control of the code 112C′, the processor 112 controls the embedded system 100 to utilize the DRAM 120 as the source.

In Step 928, under the control of the code 112C′, the processor 112 controls the embedded system 100 to utilize the Flash memory 130 as the source.

Please note that the plurality of programs is stored in the Flash memory 130. By dynamically selecting one of the first and the second memories (e.g. the Flash memory 130 or the DRAM 120) as the source, the processor 112 can manage the memory bandwidth between the embedded system 100 and the DRAM 120 in an optimal manner, in order to enhance the overall performance of the embedded system 100. For example, when the program is an audio playback program or a video playback program, the memory bandwidth between the embedded system 100 and the DRAM 120 may be insufficient due to a large amount of audio/video data. In such a difficult situation, the processor 112 can control the embedded system 100 to utilize the Flash memory 130 as the source, in order to relieve the bottleneck of the DRAM access. In another example, when the program is an initialization program or a certain program which does not consume a large amount the memory bandwidth, rather than the audio playback program or the video playback program, the memory bandwidth between the embedded system 100 and the DRAM 120 will typically be sufficient, and therefore, the processor 112 can control the embedded system 100 to utilize the DRAM 120 as the source, in order to save the time for fetching the commands of the program.

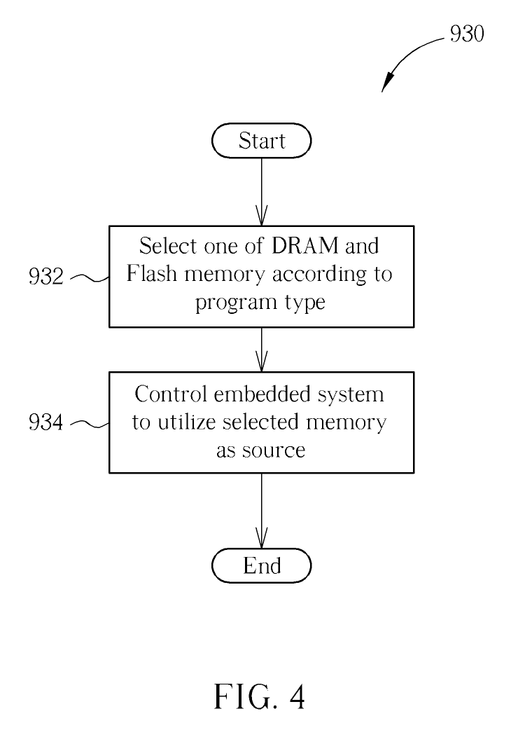

FIG. 4 illustrates a control procedure 930 comprising implementation details of the method 910 shown in FIG. 2 according to another embodiment of the present invention, where this embodiment is another operational scenario of the embodiment shown in FIG. 2. The control procedure 930 is described as follows.

In Step 932, under the control of the program code such as a code 112C″, which is another varied version of the code 112C, the processor 112 selects one of the DRAM 120 and the Flash memory 130 according to the program type of the program. For example, when the program type indicates that the program is an audio playback program or a video playback program, which requires a large amount of memory bandwidth, the processor 112 selects the Flash memory 130 as the source. In another example, when the program type indicates that the program is an initialization program or a certain program, which does not require a large amount of memory bandwidth, the processor 112 selects the DRAM 120 as the source.

In Step 934, under the control of the code 112C″, the processor 112 controls the embedded system 100 to utilize the selected memory (i.e. the Flash memory 130 or the DRAM 120 selected in Step 932) as the source. In practice, by setting at least one control register to be a predetermined value corresponding to the selected memory, the processor 112 can control the embedded system 100 to utilize the selected memory as the source.

According to another embodiment, the at least one criterion in Step 912 comprises a plurality of criteria, such as the first criterion and the second criterion implemented as the control procedures 920 and 930 respectively. For example, the control procedures 930 and 920 can be performed in serial, where Step 922 is performed following Step 934. That is, a combined control procedure of this embodiment starts with a first sub-procedure comprising Steps 932 and 934, and proceeds with a second sub-procedure comprising the loops of Steps 922, 924, 926, and 928 shown in FIG. 3. In practice, the processor 112 can set up a default memory selection according to the program type of the program, and then dynamically selects one of the first and second memories according to the latest memory bandwidth measurement result. It should be noted that this is for illustrative purposes only, and is not meant to be a limitation of the present invention. Alternatively, the processor 112 can select one of the first and the second memories according to both the first criterion and the second criterion as the default memory selection.

In practice, the processor 112 selects one of the first memory and the second memory according to the program type of the program and at least one memory bandwidth measurement result as the default memory selection, and then dynamically selects a memory according to the latest memory bandwidth measurement result. For example, the priority of the first criterion corresponding to the program type of the program and the second criterion corresponding to the memory bandwidth measurement result can be set up in advance. If the priority of the first criterion is higher than that of the second criterion, the processor 112 selects one of the first and second memories according to the first criterion first and then the second criterion.

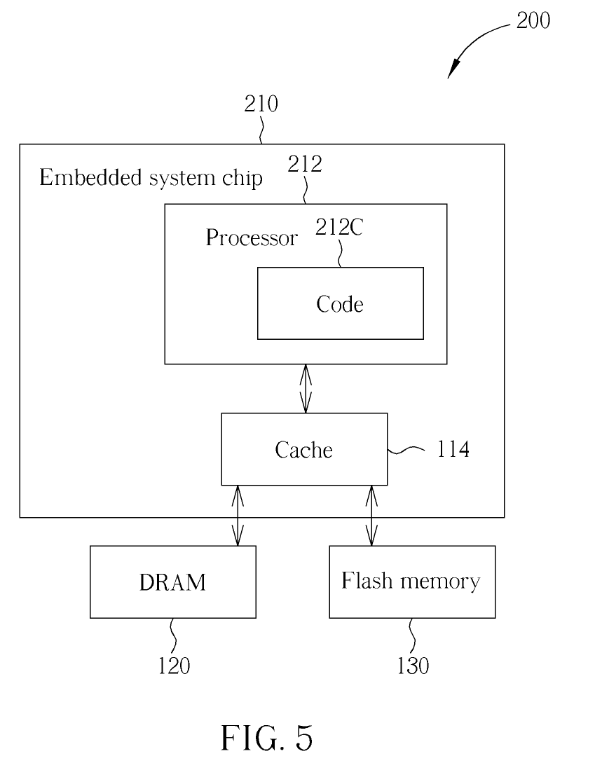

FIG. 5 is a diagram of an embedded system 200 according to a second embodiment of the present invention, wherein the embedded system 200 is similar to the embedded system 100 shown in FIG. 1 except that the bandwidth measurement unit 116 is not included herein.

Please note that the method 910 and control procedure 930 can also be applied to the embedded system 200. Those skilled in the art are able to realize how the embedded system 200 performs these operations and functions based on the above descriptions of the embedded system 100. Therefore, the descriptions for these operations and functions are redundant and not repeated herein.

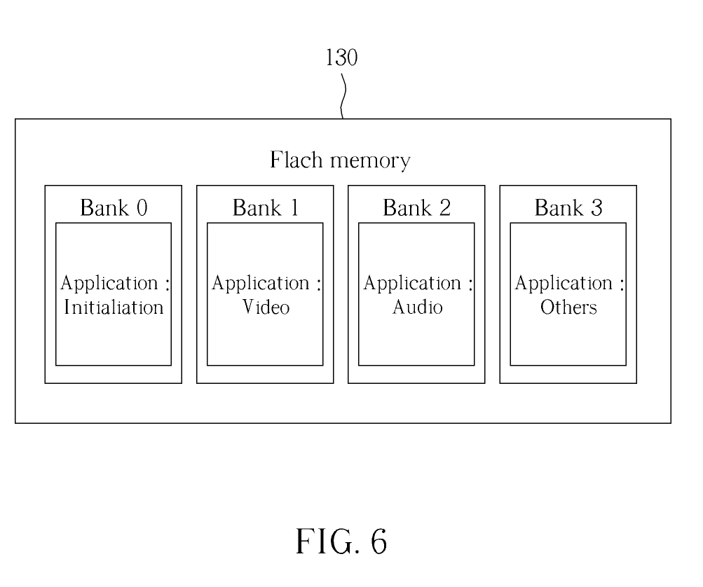

FIG. 6 illustrates an exemplary plurality of programs according to an embodiment of the present invention, wherein the programs are arranged to be stored in different memory banks such as Banks 0-3 within the Flash memory 130.

When the control procedure 930 is applied to this embodiment, the criterion can be simplified since the programs of the respective program types have been stored in predetermined memory banks such as the banks 0, 1, 2, and 3 shown in FIG. 6, respectively. For example, at least one initialization program is stored in the banks 0. In addition, video playback programs and video processing programs (labeled “Application: Video” in FIG. 6) are stored in the banks 1, and audio playback programs and audio processing programs (labeled “Application: Audio” in FIG. 6) are stored in the banks 2. Further, some other programs are stored in the banks 3. Thus, by analyzing the program types of the programs in the banks 0, 1, 2, and 3 in advance to obtain an analyzed result as a reference, the processor of this embodiment can simply select a memory as the source according to the analyzed result and the memory bank number. It should be noted that this is for illustrative purposes only, and is not meant to be a limitation of the present invention. According to a variation of this embodiment, the processor does not need to analyze the program types of the programs in the banks 0, 1, 2, and 3 in advance. In this variation, a predetermined table is provided, wherein the predetermined table comprises the relationships between the memory bank numbers and corresponding memories. Therefore, the processor can simply select a memory as the source according to the predetermined table and the memory bank number of the memory bank storing the program.

Briefly summarized, the exemplary embedded system and method for managing the embedded system manage the memory bandwidth between the embedded system and the DRAM 120 in an optimal manner, improving the performance of the embedded system.

Those skilled in the art will readily observe that numerous modifications and alterations of the device and method may be made while retaining the teachings of the invention.

What is claimed is:

1. A method for managing an embedded system, the method comprising:
selecting one of a first memory and a second memory according to at least one criterion, wherein the selected memory is a source from which the embedded system reads commands of a program, and an access speed of the first memory is different from that of the second memory; and
controlling the embedded system to execute the program by utilizing the selected memory as the source.

2. The method of claim 1, further comprising:
caching the commands of the program from the selected memory.

3. The method of claim 2, wherein both a processor for executing the program and a cache for caching the commands of the program are integrated into an integrated circuit (IC) of the embedded system.

4. The method of claim 1, wherein the access speed of the second memory is higher than the access speed of the first memory; and the method further comprises:
when the selected memory is the second memory, copying the commands of the program from the first memory to the second memory in advance, in order to control the embedded system to execute the program by utilizing the second memory as the source.

5. The method of claim 4, wherein the second memory is a volatile memory, and the first memory is a non-volatile memory.

6. The method of claim 4, wherein the criterion corresponds to at least one memory bandwidth measurement result of the second memory.

7. The method of claim 1, wherein the criterion corresponds to at least one memory bandwidth measurement result of one of the first memory and the second memory.

8. The method of claim 7, further comprising:
obtaining the at least one memory bandwidth measurement result of one of the first memory and the second memory.

9. The method of claim 8, wherein obtaining the at least one memory bandwidth measurement result comprises determining whether the at least one memory bandwidth measurement result is greater than a memory bandwidth measurement threshold, and selecting one of the first memory and the second memory according to the at least one criterion comprises selecting one of the first memory and the second memory according to a determined result of the determining step.

10. The method of claim 1, wherein the criterion corresponds to a program type of the program.

11. An embedded system, comprising:
a cache arranged to cache information for the embedded system; and
a processor arranged to control operations of the embedded system wherein the processor selects one of a first memory and a second memory according to at least one criterion, the selected memory is a source from which the embedded system reads commands of a program, and an access speed of the first memory is different from that of the second memory; and
wherein the processor controls the embedded system to execute the program by utilizing the selected memory as the source.

12. The embedded system of claim 11, wherein the processor caches the commands of the program from the selected memory with the cache.

13. The embedded system of claim 12, wherein the processor and the cache are integrated into an integrated circuit (IC) of the embedded system.

14. The embedded system of claim 11, wherein the access speed of the second memory is higher than the access speed of the first memory; and when the selected memory is the second memory, the processor copies the commands of the program from the first memory to the second memory in advance, in order to control the embedded system to execute the program by utilizing the second memory as the source.

15. The embedded system of claim 14, wherein the second memory is a volatile memory, and the first memory is a non-volatile memory.

16. The embedded system of claim 14, wherein the criterion corresponds to at least one memory bandwidth measurement result of the second memory; and the embedded system further comprises:
a bandwidth measurement unit arranged to generate the at least one memory bandwidth measurement result of the second memory.

17. The embedded system of claim 11, wherein the criterion corresponds to at least one memory bandwidth measurement result of one of the first memory and the second memory; and the embedded system further comprises:
a bandwidth measurement unit arranged to generate the at least one memory bandwidth measurement result.

18. The embedded system of claim 17, wherein the processor obtains the at least one memory bandwidth measurement result of one of the first memory and the second memory from the bandwidth measurement unit, determines whether the at least one memory bandwidth measurement result is greater than a memory bandwidth measurement threshold, and selects one of the first memory and the second memory according to a determined result thereof.

19. The embedded system of claim 11, wherein the criterion corresponds to a program type of the program.
